(19) United States
(12) Patent Application Publication
(10) Pub. No.: US 2007/0164115 A1
(43) Pub. Date: Jul. 19, 2007

(54) Automatic exposure system for imaging-based bar code reader

(75) Inventors: Eugene Joseph, Coram, NY (US); Bradley S. Carlson, Huntington, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOLTECHNOLOGIES, Inc., Holtsville, NY (US)

(21) Appl. No.: 11/332,816

(22) Filed: Jan. 17, 2006

(51) Int. Cl. G06K 7/10; G06K 9/24

(52) U.S. Cl. 235/462.21; 235/462.25; 235/462.45

(57) ABSTRACT

An automatic exposure system for an imaging-based bar code reader. The automatic identification system includes: an aiming apparatus generating a beam to aid in aiming the system at a target object when the system is actuated; an imaging system including a pixel array, a focusing lens to focus an image of the target object onto the pixel array; and an automatic exposure system to determine an integration time for capturing an image of the target object. The automatic exposure system determines an integration time by: projecting an aiming pattern on the target object and capturing an image of the aiming pattern; determining a target distance from the imaging system to the target object based on a location of the aiming pattern within the captured image; determining a gain-integration time product utilizing an equation wherein the gain-integration time product is a function of a predetermined target image brightness and the target distance; and determining the integration time by selecting a gain value and solving for integration time given the gain-integration time product.

### FIELD OF THE INVENTION

The present invention relates to an automatic exposure system for an imaging-based bar code reader.

### BACKGROUND OF THE INVENTION

Various electro-optical systems have been developed for reading optical indicia, such as bar codes. A bar code is a coded pattern of graphical indicia comprised of a series of bars and spaces of varying widths, the bars and spaces having differing light reflecting characteristics. The pattern of the bars and spaces encode information. Systems that read and decode bar codes employing imaging systems are typically referred to as imaging-based bar code readers or bar code scanners.

Imaging systems include charge coupled device (CCD) arrays, complementary metal oxide semiconductor (CMOS) arrays, or other imaging pixel arrays having a plurality of photosensitive elements or pixels. An illumination system comprising light emitting diodes (LEDs) or other light source directs illumination toward a target object, e.g., a target bar code. Light reflected from the target bar code is focused through a lens of the imaging system onto the pixel array. Thus, an image of a field of view of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals and attempts to decode the imaged bar code.

The integration time or exposure period (EP) of an imaging system is the time period between reset and read out of the electrical charges stored on each of the pixels of the pixel array. Stated another way, when the pixel array is reset, the charge on each pixel of the pixel array is substantially zeroed out. The integration time or period is a time after reset during which reflected illumination from the focusing lens field of view is focused on the pixel array and charge is accumulated on the pixels prior to the pixel array being read out. Because of the photosensitive nature of the pixels, the electrical charge stored on a pixel during an integration period is proportional to both the intensity and duration of the illumination that is focused on the pixel.

Assuming that all of the pixels of the pixel array have the same integration time, the stored charge on a pixel is dependent upon the intensity of the illumination focused on the pixel. Thus, the array of stored charges of the pixels of the pixel array provides a representative image of the field of view of the focusing lens during an integration period. Obviously, the longer the integration time, the greater the charge stored on the pixels because the reflected illumination from the field of view is being focused on the pixel array for a longer period of time.

The ability to decode a target bar code imaged in a captured image frame is dependent not only on the integration time but also on the gain factor applied to the analog signal output read out of the pixel array. Specifically, the product of integration time and the gain factor is a key element in the decodablility of a captured bar code image. Because the intensity of the reflected light projected onto the pixel array varies with a distance between the target object and the imaging assembly, determination of a proper integration time and gain factor is not a simple task.

Some imaging systems include an automatic exposure system or autoexposure system which attempts to determine a proper integration time and gain factor which result in a decodable image frame. Traditional automatic exposure systems used an iterative, trial and error approach wherein the integration time and the gain factor are varied and successive image frames are read out and analyzed until a decodable image is obtained, that is, an image where the imaged target bar code can be successfully decoded.

Such an iterative procedure to determine an acceptable integration time-gain factor product is time consuming. Moreover, if the entire pixel array is read out for each successive image frame, the delay in successful imaging and decoding is exacerbated. This is especially true in connection with so-called mega pixel imaging systems which utilize two dimensional (2D) pixel arrays with thousands of individual pixels. A typical mega pixel imaging system include pixel arrays on the order of 1280×1024 pixels or 1280×960 pixels providing for a total of approximately 1.2-1.3 million pixels.

Typically read times for bar code readers range from 80 milliseconds (ms) to a few hundred milliseconds. Read time includes the total time to image and decode a target bar code. Read time differences of around 10 ms can result in measurable differences in productivity. Thus, reducing the delay time required to determine a satisfactory integration period in imaging based bar code readers is very desirable, especially in 2D mega pixel imaging systems.

What is desired is an automatic exposure system for an imaging-based bar code reader with a 2D imaging system that reduces the time required to obtain a satisfactory exposure for imaging and decoding a target image such as a target bar code.

### SUMMARY OF THE INVENTION

The present invention includes an automatic exposure system for use in an imaging-based automatic identification system, such as a bar code reader. The bar code reader includes a 2D imaging system, an illumination system for illuminating a target object, such as a target bar code, and an aiming apparatus, such as a laser aiming apparatus to aid a user of the reader in aiming the reader at the target object.

The imaging system includes a 2D pixel array and a focusing lens to focus reflected light from the target object onto the pixel array. The imaging system further includes an automatic exposure system for determining an integration or exposure time as to reduce the time required to capture a decodable image of the target object. The integration time is a time during which the reflected light from the target object is focused onto the pixel array and the pixel array is in a state such that the pixels receive the reflected light and accumulate an electrical charge the magnitude of which depends on the intensity of the light focused on the individual pixels.

The automatic exposure system determines an integration time by:

1) projecting an aiming pattern on the target object and capturing an image of the aiming pattern;

2) determining a target distance from the imaging system to the target object based on a location of the aiming pattern within the captured image;

3) determining a gain-integration time product utilizing an equation wherein the gain-integration time product is a function of a predetermined target image brightness and the target distance; and

4) determining the integration time by selecting a gain value and solving for integration time given the gain-integration time product.

The present invention includes a method of determining an integration time for imaging a target object utilizing an imaging system including a 2D pixel array and an aiming apparatus including the steps of:

1) projecting an aiming pattern on the target object and capturing an image of the aiming pattern;

2) determining a target distance from the imaging system to the target object based on a location of the aiming pattern within the captured image;

3) determining a gain-integration time product utilizing an equation wherein the gain-integration time product is a function of a predetermined target image brightness and the target distance; and

4) determining the integration time by selecting a gain value and solving for integration time given the gain-integration time product.

These and other objects, advantages, and features of the exemplary embodiment of the invention are described in detail in conjunction with the accompanying drawings.

### BRIEF DESCRIPTION OF THE DRAWINGS

FIG. 1 is a side elevation view of an imaging-based bar code reader of the present invention including an automatic exposure system;

FIG. 2 is a schematic block diagram of an imaging-based bar code reader of FIG. 1;

FIG. 3 is a flow chart of the overall functioning of the automatic exposure system;

FIG. 4 is schematic diagram of a laser beam aiming apparatus of the bar code reader of FIG. 1 which is used to determine range from imaging engine to target object; and

FIG. 5 is a representation of a look up table providing values of the function K(Z, I) upon input of values of target distance Z.

### DETAILED DESCRIPTION

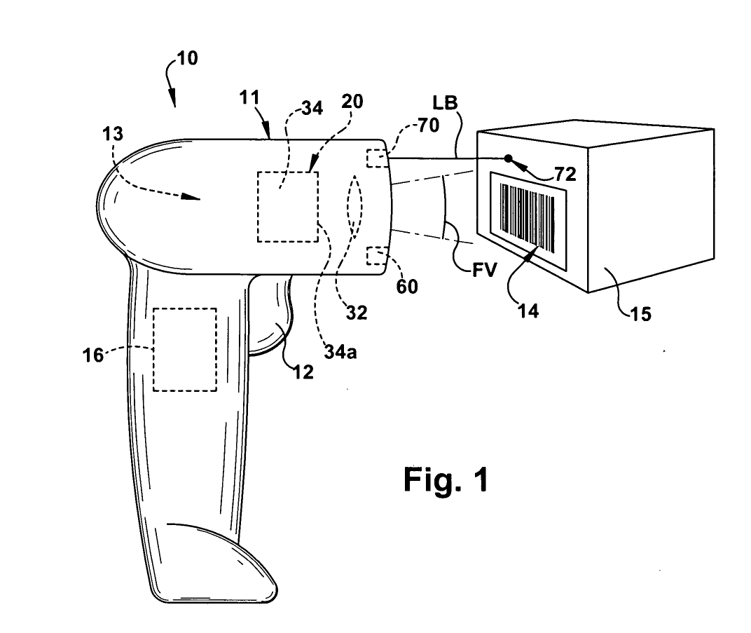

An imaging-based reader, such as an imaging-based bar code reader, is shown schematically at 10 in FIG. 1. The bar code reader 10, in addition to imaging and decoding both 1D and 2D bar codes and postal codes, is also capable of capturing images and signatures. The bar code reader 10 includes an imaging system or engine 20 for imaging and decoding captured images and features an automatic exposure system 22, to be described below.

In one preferred embodiment of the present invention, the bar code reader 10 is a hand held portable reader encased in a pistol-shaped housing 11 adapted to be carried and used by a user walking or riding through a store, warehouse or plant for reading bar codes for stocking and inventory control purposes. However, it should be recognized that the automatic exposure system 22 of the present invention may be advantageously used in connection with any type of imaging-based automatic identification system including, but not limited to, bar code readers, signature imaging acquisition and identification systems, optical character recognition systems, fingerprint identification systems and the like. It is the intent of the present invention to encompass all such imaging-based automatic identification systems.

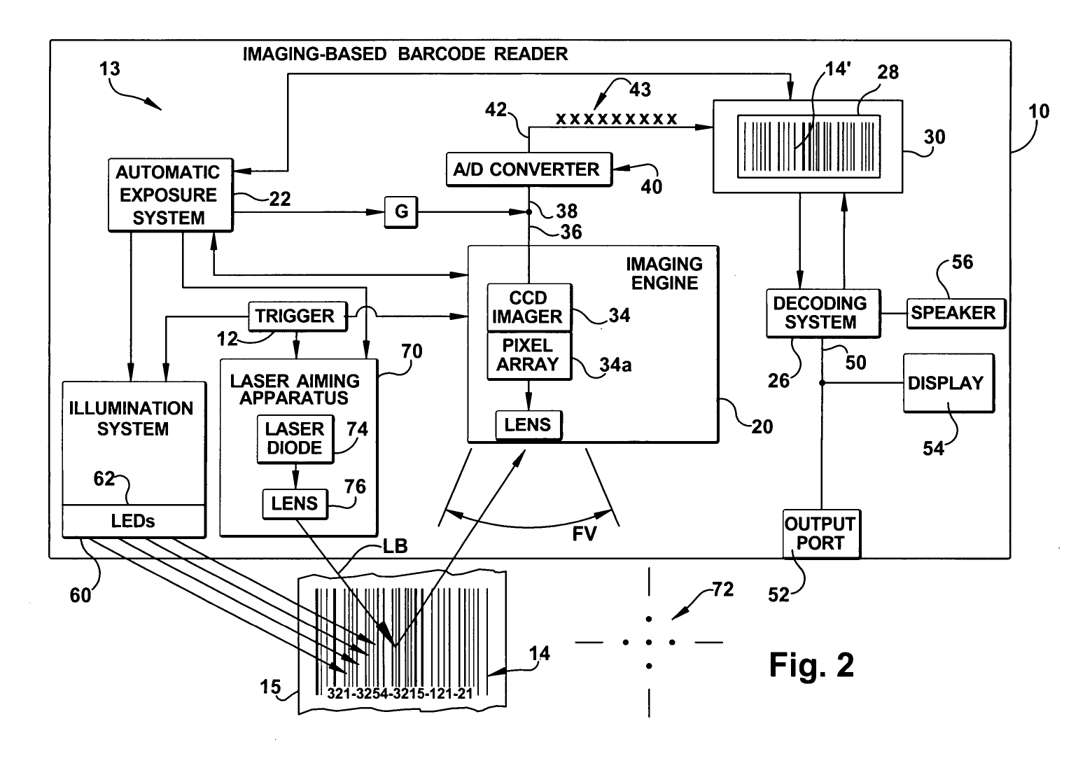

The bar code reader 10 includes a trigger 12 coupled to bar code reader circuitry 13 for initiating reading of target indicia, such as a target bar code 14 positioned on an object 15 when the trigger 12 is pulled or pressed. The bar code reader circuitry 13 and the imaging system 20 coupled to a power supply 16. The bar code reader 10 includes the imaging system 20 for imaging the target bar code 14 and decoding a digitized image 14′ (shown schematically in FIG. 2) of the target bar code 14.

The imaging system 20 includes imaging circuitry 24, of which the automatic exposure system 22 is part, and decoding circuitry 26 for decoding the imaged target bar code 14′ (shown schematically in FIG. 2) within an image frame 28 stored in a memory 30. The imaging and decoding circuitry 24, 26 may be embodied in hardware, software, firmware, electrical circuitry or any combination thereof.

The imaging engine 20 further includes a focusing lens 32 and an imager 34, such as a charged coupled device (CCD), a complementary metal oxide semiconductor (CMOS), or other imaging pixel array, operating under the control of the imaging circuitry 24. For simplicity, the imager 34 will be referred to as a CCD imager.

The focusing lens 32 focuses light reflected from the target bar code 14, as well as ambient illumination from the lens field of view FV, onto an array of photosensors or pixels 34a of the CCD imager 34. Thus, the focusing lens 32 focuses an image of the target bar code 14 (assuming it is within the field of view FV) onto the pixel array 34a. The focusing lens 32 field of view FV includes both a horizontal and a vertical field of view. While the focusing lens 32 shown in FIG. 1 is a fixed position lens, it should be appreciated that the automatic exposure system 22 of the present invention may also be advantageously utilized with a focusing lens that moves along a path of travel under the control of an automatic focusing system of the type disclosed in U.S. application Ser. No. 10/903,792, filed Jul. 30, 2005. application Ser. No. 10/903,792 is assigned to the assignee of the present invention and is incorporated herein in its entirety by reference.

In one exemplary embodiment, the CCD imager 34 includes a two dimensional (2D) mega pixel array 34a. A typical size of the pixel array 34a is on the order of 1280×1024 pixels. Electrical charges are stored on the pixels of the pixel array 34a during an integration time or exposure period EP selected by the automatic exposure system 22. After the integration time EP has elapsed, some or all of the pixels of pixel array 34a are successively read out thereby generating an analog signal 36. As explained below, the automatic exposure process may be expedited by utilizing windowing or binning. The concept of windowing or binning is that instead of reading out and analyzing the entire pixel array 34a, only those portions of the pixel array that correspond to an image of interest (e.g., an image of the target bar code or an aiming pattern) are read out and analyzed, thus, saving read out time and subsequent analysis time.

The analog image signal 36 represents a sequence of photosensor voltage values, the magnitude of each value representing an intensity of the reflected light received by a photosensor/pixel during an integration or exposure period EP. The analog signal 36 is amplified by a gain factor G selected by the automatic exposure system 22, generating an amplified analog signal 38. The imaging circuitry 24 further includes an analog-to-digital (A/D) converter 40. The amplified analog signal 38 is digitized by the A/D converter 40 generating a digitized signal 42. The digitized signal 42 comprises a sequence of digital gray scale values 43 ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness). For example, the focusing lens 32 focuses an image of the target bar code onto the pixel array 34a.

Focused on certain pixels of the pixel array 34a will be an image corresponding to the black bars of the target bar code 14 while other pixels of the pixel array will have focused on them an image corresponding to the white or light colored spaces of the target bar code. Those pixels corresponding to an image of a black bar of the target bar code 14 would be expected to have relatively low gray scale values because the color black is a light absorber, while those pixels corresponding to an image of a white space of the target bar code would be expected to have relatively high gray scale values because the color white is a light reflector.

The digitized gray scale values 43 of the digitized signal 42 are stored in the memory 30. The digital values 43 corresponding to a read out of the pixel array 34a constitute the image frame 28, which is representative of the image projected by the focusing lens 32 onto the pixel array 34a during an integration period. If the field of view FV of the focusing lens 32 includes the target bar code 14, then a digital gray scale value image 14′ of the target bar code 14 would be present in the image frame 28.

The gray scale values 43 of the image frame 28 stored in memory 30 are operated on by the decoding circuitry 26 to binarize the gray scale values, that is, convert the gray scale values which range from 0 to 255 to binary values of 0 or 1 using a decision rule. The decoding circuitry 26 then operates on the binary values of the image frame 28 and attempts to decode any decodable image within the image frame, e.g., the imaged target bar code 14′.

If the decoding is successful, decoded data 50, representative of the data/information coded in the bar code 14 is then output via a data output port 52 and/or displayed to a user of the reader 10 via a display 54. Upon achieving a good “read” of the bar code 14, that is, the bar code 14 was successfully imaged and decoded, a speaker 56 is activated by the bar code reader circuitry 13 to indicate to the user that the target bar code 14 has successfully read, that is, the target bar code 14 has been successfully imaged and the imaged bar code 14′ has been successfully decoded.

The bar code reader 10 further includes an illumination assembly 60 for illuminating the field of view of the focusing lens 32 and an aiming apparatus 70 for generating a visible aiming pattern 72 to aid the user in properly aiming the reader at the target bar code 14. The illumination assembly 60 and the aiming apparatus 70 operate under the control of the imaging circuitry 24. In one preferred embodiment, the illumination assembly 60 includes one or more banks of LEDs which, when energized, project light along the field of view FV of the focusing lens 32. Preferably, the illumination provided by the illumination assembly 60 is intermittent or flash illumination as opposed to continuously on illumination to save on power consumption. The flash rate is typically on the order of 10 flashes/sec.

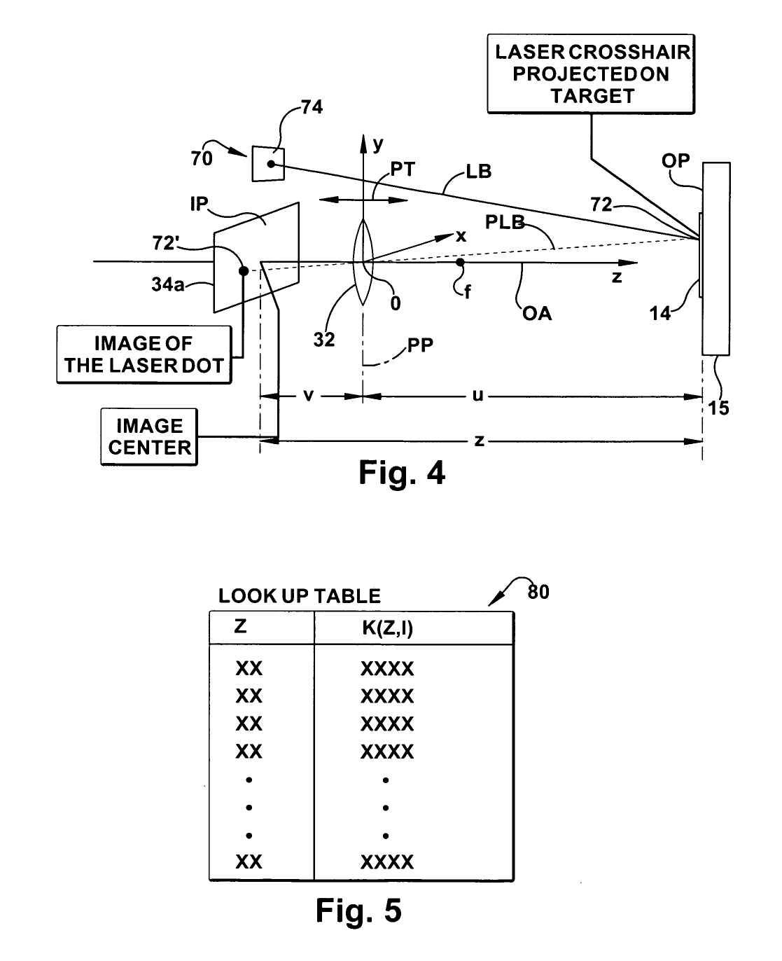

In one exemplary embodiment, the aiming apparatus 70 is a laser aiming apparatus. The aiming pattern 72 may be a pattern comprising a single dot of illumination (FIG. 4), a plurality of dots and/or lines of illumination (FIG. 1) or overlapping groups of dots/lines of illumination. Typically, the laser aiming apparatus 70 includes a laser diode 74 and a diffractive lens 76.

Automatic Exposure System 22

The imaging system 20 includes the automatic exposure system 22 which, via the imaging circuitry 24, controls the integration or exposure period EP and the gain factor G applied to the analog signal 36 read out from the pixel array 34a. The automatic exposure system 22 reduces the time required to acquire a properly exposed and decodable image of the target bar code 14 by: a) decreasing the number of image captures required to acquire a properly exposed image; and b) decreasing a transfer time of the captured images from the pixel array 34a to the A/D converter 40 and to the memory 30 by requiring only a portion of a captured image to be transferred via windowing/binning.

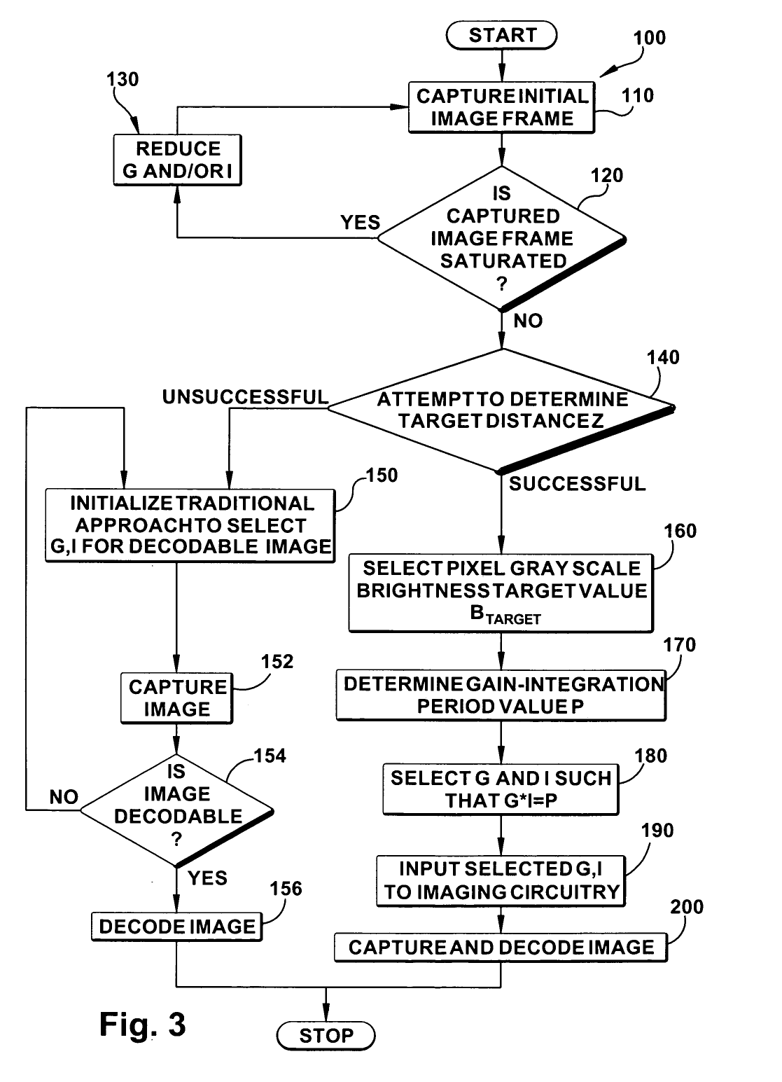

As shown in the flow chart of FIG. 3 at 100, the automatic exposure system 22 employs a multi-step process to determine an integration or exposure time EP during which reflected light from the target bar code 14 is focused on the pixel array 34a and the pixels are in a condition to receive the light and build up electrical charges, prior to reading out some or all of the pixel array 34a. The first step, shown at 110 in FIG. 3, upon actuation of the trigger 12 by a user, the automatic exposure system 22, through the imaging circuitry 24 actuates the CCD imager 34 to capture an initial image frame of the target bar code 14. The initial image is captured using preset values for the integration period EP and the gain factor G. During the integration period EP, the illumination assembly 60 is off (not actuated) while the laser aiming apparatus 70 is actuated to facilitate the user properly aiming the housing 11 at the target bar code 14, and to facilitate the identification of the aiming pattern 72 in the acquired or captured initial image.

At step 120, the automatic exposure system 22 determines if the captured image frame is saturated. The image is considered saturated if an unacceptably large portion (by way of example, 10% or more) of the gray scale values corresponding to the read out pixel charges for the captured frame are at the maximum value of 255.

If the captured image frame is saturated, at step 130, the automatic exposure system 22 reduces the gain factor G and/or reduces the integration period EP and the process returns to step 110 to capture another image frame. The loop continues until a non-saturated image is captured. If the captured image frame is not saturated, at step 140 a distance Z between the pixel array 34a and the target bar code 14 is determined using the laser ranging algorithm discussed below.

At step 140, the automatic exposure system 22 determines if the target distance Z has been found. If the target distance Z cannot be determined, the automatic exposure system 22 turns on the illumination assembly 60 and utilizes a traditional exposure control algorithm such as a trial-and-error iterative method to select an integration period EP and a gain factor G that allows for successful decoding of the imaged bar code 14′, as shown at steps 150, 152, 154, 156.

If at step 140, the target distance Z is successfully determined, then at step 160 the automatic exposure system 22 is provided a pixel gray scale brightness target value (Btarget) for those pixels onto which an image of the target bar code 14 is projected. In other words, assuming the imaging circuitry 24 includes an eight bit A/D converter 40, the gray scale target value Btarget would be a gray scale value between 0 and 255. The gray scale target value Btarget corresponds to the digitized gray scale values 43 of the digitized signal 42 discussed above. In essence, the Btarget value represents the desired brightness or total charge of the pixels that are imaging the target bar code 14. The gray scale target value Btarget is provided for those portions of the imaged bar code 14′ that correspond to the white spaces, e.g., 120+/−10%. Providing a Btarget value for the imaged black bars is not appropriate because the variation of the imaged black bars with change in exposure time is small, i.e., black should be imaged as black independent of exposure and/or gain.

Once the gray scale target value Btarget is selected, then at step 170, the automatic exposure system 22 utilizes an equation (discussed below) to calculate a desired gain-integration period value P. The desired gain-integration period value P is the multiplicative product of the gain factor G and integration period EP.

At step 180, the automatic exposure system 22, after determining the desired gain-integration period value P, selects a suitable gain factor G and integration time EP such that the product of G and EP equals or substantially equals the desired gain-integration period value P.

At step 190, the selected gain factor G and integration time EP are input to the imaging circuitry 24. At step 200, the imaging circuitry 24 actuates the CCD imager 34 and the illumination system 60 and utilizes the selected values of G and EP to capture an image of the target bar code 14 for processing and decoding by the decoding circuitry 26, as discussed above.

Laser Ranging

Step 140 described above includes the task of determining the distance Z between the pixel array 34a and the target bar code 14. This is accomplished by laser ranging. The discussion here will assume that the focusing lens 32 is in a fixed position. If the focusing lens 32 is movable along a path of travel, laser ranging may still be used to determine the distance Z. Laser ranging in such a situation is disclosed in previously referenced application Ser. No. 10/903,792, assigned to the assignee of the present invention and incorporated herein in its entirety by reference

The laser diode 74 produces the aiming pattern 72 that assists the user in aiming the reader at the target bar code 14. Using the laser light reflected from the target bar code 14, the same laser beam pattern 72 can be used to determine the target distance Z (FIG. 4) from the pixel array 34a to the target bar code 14.

Essentially, the algorithm computes the distance Z from a location of an image of the laser aiming pattern 72 within the image projected onto the pixel array 34a. The location of the laser aiming pattern 72 varies with the target distance Z due to parallax between the aiming and imaging systems 70, 20.

The laser light emitted by the laser diode 74 to generate the laser aiming pattern 72 travels outwardly toward the target bar code 14. The laser beam impacts the bar code 14 or the object 15 the bar code is affixed to and is reflected back toward the reader 10 where it is focused on the pixel array 34a by the lens 32. As can be seen in FIG. 4, the target distance Z is equal to the sum of image distance v and object distance u. The image distance v is the distance between the principal plane PP of the focusing lens 32 and the image plane IP, that is, a light receiving surface of the pixel array 34a, along an optical axis OA of the lens 32. Since the lens 32 is fixed, the distance v is known.

The object distance u is the distance between the principal plane PP of the lens 32 and the object plane OP, that is, a surface of the target bar code 14, along the optical axis OA of the lens. The object distance u is computed using a parallax distance algorithm.

In order to estimate the distance u of the lens 32 to the bar code 14, the laser beam is projected onto the target bar code 14 and an image 72′ of the laser pattern 72 reflected from the bar code 14 is projected onto the pixel array 34a. Turning to FIG. 3, the z-axis of the reference coordinate system is defined by the optical axis, OA, and the origin 0 is defined by the intersection of the z-axis with the principal plane PP of the lens 32. A 3D vector V is represented by:
V=v+z\hat{z}, v·\hat{z}=0,
where v is the projection of Von the image plane (that is, the plane of the pixel array 34a) and z is the projection on the z-axis.
The laser beam (the line labeled LB in FIG. 4) can be modeled as a 3D line:
l=g+βz (1)
where g and β are 2D vectors that define the position and direction of the laser beam, respectively. Let a be a 2D vector that represents Pᵢ, the projection of the laser dot P on the image plane. According to the law of perspective projection:
l=αz, α=f_{bl}vpₚᵢ, (2)
where f_{bl} is the back focal length and vₚᵢ is the 2D coordinate of Pᵢ.

Combining equations (1) and (2) and solving for z:

$$z = \frac{{g}^{2}}{( α - β ) g} . \qquad ( 3 )$$

g and β can be obtained through calibration. Once the laser dot is located in the image, z can be computed using equation (3). Note that the back focal length f does not appear in (3) since α is represented in number of pixels. The object distance u of the principal plane PP of the lens 32 to the target bar code 14 is, therefore, u=z.

Thus, the target distance Z=v+u=v+z. The image distance v is known and the object distance u is equal to z, as computed above.

Gain—Integration Time Product Equation

In step 170, the automatic exposure system 22 determines the gain-integration time product P using the equation below. The automatic exposure system 22 takes the predetermined value of the gray scale target value Btarget and it also has the parameters for the initial autoexposure image capture, namely the gain factor G and the integration period EP used in the initial image capture. Moreover, the automatic exposure system 22 can calculate the average pixel brightness for the initial autoexposure image capture (illumination assembly off during initial image capture). The equation, which is solved for P, is as follows:

$$Btarget = \frac{( Bcross * P )}{Pcross} + K ( Z , I ) * P$$

wherein:
Btarget=Predetermined pixel gray scale target value (given value in gray scale units)
Bcross=Average pixel brightness resulting from ambient illumination in the initial image capture (gray scale units)
P=Gain-integration time product value (the term being solved for)
Pcross=Gain-integration time product value of initial image capture, i.e., G*EP for initial image capture
K(Z, I)=Value that is a function of target distance Z and which is found in a look up table (FIG. 4)

The first term in the equation is the contribution to captured image (pixel) brightness as a result of ambient illumination. Bcross is the average pixel brightness observed in the captured initial image (step 110) for pixels other than the pixels onto which the laser aiming pattern image 72′ is projected. The pixels that the aiming pattern image is focused on are ignored. Recall that the illumination assembly 60 is off during the initial image capture. Thus, the gray scale level of the pixels of the pixel array 34a (other than those pixels receiving the laser aiming pattern image 72′) is a measure of the ambient illumination focused onto the pixel array 34a. Pcross is simply the product of the gain factor G and the integration time EP used when capturing the initial image (step 110).

The second term in the equation is the contribution to the image (pixel) brightness from the illumination system 60. The function K(Z, I) is the ratio of the image brightness observed to the gain-integration time product P used when images are taken with only the illumination assembly 60 generated flash illumination of intensity I of the target bar code 14 at a target distance Z. For any given flash intensity I, the function K(Z, I) should be inversely proportional to Z² and can be measured empirically. The empiric measurements or calibration of the function K(Z, I) can be performed at the time of manufacture of the reader 10 or in real time during use of the reader 10. Real time measurement of the function K(Z, I) would allow the value to be adjusted as the illumination system 60 ages or undergoes some other light intensity change. For illustration purposes, FIG. 5 shows a typical look up table 80 of the type that would be stored in the memory 30. The look up table 80 provides values of K(Z, I) as a function of target distance Z. The look up table 80 would be accessed by the automatic exposure system 22 in computing P once the target distance Z was computed using the laser ranging algorithm described above.

The speed of the automatic exposure process can be made faster if an imaging sensor of the imaging circuitry 24 supports windowing and/or binning. This is accomplished by reading only the parts of the image where the defining feature of the aiming pattern 72, e.g., a dot or crosshair, is expected to be located. The opto-mechanical layout of the aiming apparatus 70 and the imaging system 20 can minimize the readout window as follows. Assume that the optical axis OA of the focusing lens 32 and an optical axis (shown by line LD in FIG. 4) of the aiming apparatus 70 are horizontal and the rows of pixels of the pixel array 34a are also horizontal.

A size of the window image required to capture an image of the aiming pattern 72 is reduced by decreasing the offset between the optical axis LD of the aiming apparatus 70 and the optical axis OA of the focusing lens 32. Stated another way, locate the imaging system 20 and the aiming apparatus 70 horizontally with respect to each other.

If the initial image acquired with the aiming apparatus 70 on does not contain statistically relevant data (for example, contrast modulation), one approach would be to not activate the illumination assembly 60. The idea is that if an image is properly exposed and no bar code is present in the image, it is inefficient to continuously flash looking for a bar code. Depending on the ambient light level, it is sometimes the case that the presence of the bar code in the captured image may be detected even if the illumination assembly 60 is off. If the presence of the bar code is not detected in the capture image, then it can be assumed that the user is not pointing the reader 10 at the target bar code 14 and the imaging system 20 does not attempt to read a bar code. Another approach would be to use the illumination system 60 to generate short flashes and utilize truncated or partial image frames to limit the intensity of the flash while searching for the presence of the bar code in the captured image.

With either approach, limiting the number of flashes generated by the illumination assembly 60 minimizes power dissipation and improves user ergonomics by limiting bright flashes from the illumination assembly. This is especially true for rolling shutter imaging systems that require the illumination to be on for the entire read out time, independent of the exposure time, that is, the illumination assembly 60 is on for the entire read out time, even if the exposure time is less than the read out time.

If the aiming pattern 72 cannot be found in the initial captured image, then the automatic exposure system 22 defaults to a traditional exposure control algorithm where trial-and-error iteration may be required to converge on an acceptable exposure time. Even in a situation where a traditional exposure control algorithm must be used, the imaging circuitry 24 can utilize the windowing/binning method described above to read out and analyze only the relevant portion of the pixel array 34a having the imaged aiming pattern 72′ to speed the automatic exposure process and limit the extent of the illumination.

While the present invention has been described with a degree of particularity, it is the intent that the invention includes all modifications and alterations from the disclosed design falling within the spirit or scope of the appended claims.

We claim:

1. An automatic identification system comprising:
a) an aiming apparatus generating a beam to aid in aiming the system at a target object when the system is actuated;
b) an imaging system including a pixel array, and a focusing lens to focus an image of the target object onto the pixel array; and
d) an automatic exposure system to determine an integration time for capturing an image of the target object, the automatic exposure system determining an integration time by:
1) projecting an aiming pattern on the target object and capturing an image of the aiming pattern;
2) determining a target distance from the imaging system to the target object based on a location of the aiming pattern within the captured image;
3) determining a gain-integration time product value utilizing an equation wherein the gain-integration time product value is a function of a predetermined target image brightness value and the target distance; and
4) determining the integration time by selecting a gain value and solving for integration time given the gain-integration time product value.

2. The automatic identification system of claim 1 wherein automatic identification system is a bar code reader and the target object is a target bar code to be imaged and decoded.

3. The automatic identification system of claim 2 wherein the imaging system includes imaging circuitry and decoding circuitry for imaging and decoding an image of the target bar code, the integration time being used when capturing the image of the target bar code.

4. The automatic identification system of claim 1 wherein the imaging assembly includes an illumination assembly for illuminating the target object.

5. The automatic identification system of claim 4 wherein the illumination assembly generates flash illumination.

6. The automatic identification system of claim 4 wherein the equation utilized for determining the gain-integration time product value is the following:
$$Btarget = \frac{( Bcross * P )}{Pcross} + K ( Z , I ) * P$$
wherein:
Btarget=the predetermined target image brightness value;
Bcross=value for average pixel brightness resulting from ambient illumination in an initial image capture;
P=the gain-integration time product value to be solved for;
Pcross=gain-integration time product value of initial image capture, i.e., G*EP for the initial image capture; and
K(Z, I)=a value that is a function of target distance Z and an intensity I of the illumination assembly.

7. The automatic identification system of claim 6 wherein the values for Btarget and Bcross are in gray scale units and the value for K(Z, I) is found in a look up table.

8. The automatic identification system of claim 6 wherein the illumination assembly is off during the initial image capture.

9. The automatic identification system of claim 1 wherein the aiming apparatus is a laser aiming apparatus and the beam is a laser beam pattern.

10. The automatic identification system of claim 2 wherein the step of determining a target distance from the imaging system to the target object based on a location of the aiming pattern within the captured image utilizes a distance algorithm that is based on parallax between the aiming apparatus and the imaging system.

11. The automatic identification system of claim 10 wherein the distance algorithm is a parallax distance algorithm based on the parallax or offset between the beam and an imaging axis.

12. The automatic identification system of claim 1 wherein the aiming apparatus includes a laser diode and a diffractive optical element to project the laser beam pattern on the target object.

13. The automatic identification system of claim 1 wherein the pixel array is a 2D pixel array.

14. A method of determining an integration time for imaging a target object utilizing an imaging system including a 2D pixel arrayg apparatus comprising the steps of
a) determining a target distance from the imaging system to the target object;
b) determining a gain-integration time product value utilizing an equation wherein the gain-integration time product value is a function of a predetermined target image brightness and the target distance; and
c) determining the integration time by selecting a gain value and solving for integration time given the gain-integration time product value.

15. The method of claim 14 wherein the imaging system includes an aiming apparatus for projecting an aiming pattern at the target object and the step of determining a target distance from the imaging system to the target object includes the substeps of: projecting the aiming pattern at the target object, capturing an image of the aiming pattern, and determining the target distance based on a location of the aiming pattern within the captured image.

16. The method of claim 14 wherein the equation utilized for determining the gain-integration time product value is the following:
$$Btarget = \frac{( Bcross * P )}{Pcross} + K ( Z , I ) * P$$
wherein:
Btarget=the predetermined target image brightness value;
Bcross=the value for average pixel brightness resulting from ambient illumination in an initial image capture;
P=the gain-integration time product value to be solved for;
Pcross=gain-integration time product value of initial image capture, i.e., G*EP for the initial image capture; and
K(Z, I)=value that is a function of target distance Z and an intensity I of the illumination assembly.

17. An imaging system for a bar code reader comprising:
a) an imaging engine including a pixel array and a focusing lens to focus an image of the target object onto the pixel array;
b) imaging and decoding circuitry for capturing an image of the target bar code and decoding an image of the target bar code within the captured image; and
c) an automatic exposure system to determine an integration time for capturing an image of the target bar code, the automatic exposure system determining an integration time by:
1) determining a target distance from the imaging system to the target bar code;
2) determining a gain-integration time product value utilizing an equation wherein the gain-integration time product value is a function of a predetermined target image brightness value and the target distance; and
3) determining the integration time by selecting a gain value and solving for integration time given the gain-integration time product value.

18. The imaging assembly of claim 17 wherein determining a target distance from the imaging system to the target bar code includes projecting an aiming pattern at the target object, capturing an image of the aiming pattern, and determining the target distance based on a location of the aiming pattern within the captured image.

19. The imaging assembly of claim 17 wherein the equation utilized for determining the gain-integration time product value is the following:
$$Btarget = \frac{( Bcross * P )}{Pcross} + K ( Z , I ) * P$$
wherein:
Btarget=the predetermined target image brightness value;
Bcross=value for average pixel brightness resulting from ambient illumination in an initial image capture;
P=the gain-integration time product value to be solved for;
Pcross=gain-integration time product value of initial image capture, i.e., G*EP for the initial image capture; and
K(Z, I)=a value that is a function of target distance Z and an intensity I of the illumination assembly.

20. An automatic exposure system for use in an automatic identification system including an imaging system including a pixel array, and a focusing lens to focus an image of the target object onto the pixel array, the automatic exposure system comprising circuitry for determining an integration time for capturing an image of the target object by:
a) determining a target distance from the imaging system to the target bar code;
b) determining a gain-integration time product value utilizing an equation wherein the gain-integration time product value is a function of a predetermined target image brightness value and the target distance; and
c) determining the integration time by selecting a gain value and solving for integration time given the gain-integration time product value.

21. The automatic exposure system of claim 20 wherein determining a target distance from the imaging system to the target bar code includes projecting an aiming pattern at the target object, capturing an image of the aiming pattern, and determining the target distance based on a location of the aiming pattern within the captured image.

22. The automatic exposure system of claim 20 wherein the equation utilized for determining the gain-integration time product value is the following:
$$Btarget = \frac{( Bcross * P )}{Pcross} + K ( Z , I ) * P$$
wherein:
Btarget=the predetermined target image brightness value;
Bcross=value for average pixel brightness resulting from ambient illumination in an initial image capture;
P=the gain-integration time product value to be solved for;
Pcross=gain-integration time product value of initial image capture, i.e., G*EP for the initial image capture; and
K(Z, I)=a value that is a function of target distance Z and an intensity I of the illumination assembly.
